(19) United States
(12) Patent Application Publication
(10) Pub. No.: US 2006/0232789 A1
(43) Pub. Date: Oct. 19, 2006

(54) Position referencing system

(76) Inventors: Jae-Hyuk Oh, Tolland, CT (US); Pengji Kang, Hartford, CT (US); Alan Finn, Hebron, CT (US); Pei-Yuan Peng, Ellington, CT (US); Charles Zdzislaw Loboz, West Ryde (AU); Jonatan Kelu, Granville (AU); Paul Edward Claude Street, Westleigh (AU)

Correspondence Address: BACHMAN & LAPOINTE, P.C. (UTC), 900 CHAPEL STREET, SUITE 1201, NEW HAVEN, CT, 06510-2802, US

(21) Appl. No.: 10/541,229

(22) PCT Filed: Dec. 30, 2002
(86) PCT No.: PCT/US02/41515

§ 371 Date: May 24, 2006

(51) Int. Cl. G01B 11/14

(52) U.S. Cl. 356/614

(57) ABSTRACT

The present invention relates to a position referencing system and method for horizontal or vertical conveyance, e.g., an elevator. The position referencing system includes a plurality of spaced apart color elements or reflectors (42) attached to a static structure (40), such as a door frame in a hoistway or guideway, a light source (12) for illuminating one of the reflectors, and a sensing device (10, 48, 48′) for capturing an image of the illuminated reflector. The image captured by the sensing device is used to determine the position and/or speed of the conveyance, e.g., an elevator car.

### BACKGROUND OF THE INVENTION

The present invention relates to a system and a method for low-cost and high-performance absolute position referencing for elevators and other (passenger) conveyances such as horizontal passenger conveyances.

A position referencing system is a component of a control system that provides fast and accurate position measurement of an elevator car in a hoistway or a (passenger) cab along a guideway. The speed and accuracy of a position referencing system is determined from a given control system in the way of guaranteeing a certain level of ride quality. One example is that position measurement should be performed within 10 ms lag and 1 mm accuracy. Considering the wide operating range (up to 500 m) of elevators and the long distance between stops of a (passenger) conveyance, these performance requirements are quite demanding. In addition to the performance requirements on accuracy and measurement lag, a minimized correction run, occurring for instance at power-on, is the other important performance requirement. In this context, “minimized” means less than one-floor or one-stop in distance.

In the following description, an elevator will be used as illustrative of horizontal or vertical (passenger) conveyances without prejudice.

Many existing position referencing systems for elevators are based on encoders that are attached to the drive motor, governor, or independent sheaves. These position referencing systems suffer from differences between the encoder reading and the real position that is caused by slippage, rope stretch, mechanical wear in subsystems, and/or building sway. To minimize these differences, correction needs to be performed frequently based on some fixed and known referencing points showing the real position of the landing floor and leveling zone. A vane system, consisting of vane reader and vanes, provides these referencing points and their detection means. Considering the simple functionality of the vane system, the vane system is quite cost inefficient since a vane which is installed by a mechanic in the hoistway, costs $10 for material, 0.5 hours for installation, and about 0.1 hour for adjustment for every floor. Overall, one of the most significant problems in the existing position referencing systems is the poor performance to cost ratio.

### SUMMARY OF THE INVENTION

Accordingly, it is an object of the present invention to provide a position referencing system and method that has fine accuracy, minimized correction run, and easy installation and easy maintenance.

It is a further object of the present invention to provide a position referencing system and method as above which has no hoistway or guideway installation.

The foregoing objects are attained by the position referencing system and method of the present invention.

In accordance with the present invention, a position referencing system broadly comprises a plurality of spaced apart color elements attached to a static structure, means attached to a movable structure for detecting one of the spaced apart color elements, and means for determining a position of the movable structure from the detected color element. As used herein, the term “color” designates not only visible colors but also invisible colors in the electromagnetic spectrum including ultraviolet, infrared, radio frequency, and microwave. As used herein, the term “movable structure” may be an elevator car or a horizontal passenger conveyance.

Further, in accordance with the present invention, a position referencing method broadly comprises the steps of attaching a plurality of spaced apart color elements to a static structure, detecting one of the spaced apart color elements, and determining a position of a movable structure from the detected color element.

Other details of the position referencing system and method of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of a charge coupled device (CCD) based positioning system;

FIG. 2 is a schematic representation of a red, green, blue (RGB) decomposition of a color CCD image;

FIGS. 3A and 3B are a schematic representation of a position referencing system in accordance with the present invention; and

FIG. 4 is a schematic representation of a code in color (CiC) CCD based position referencing system.

### DETAILED DESCRIPTION OF THE PREFERRED EMBODIMENT(S)

Referring now to the drawings, FIG. 1 illustrates how a one-dimensional charge coupled device (CCD) 10 based relative positioning system works. That is, a reflector 11 is illuminated by a light source or a linear radiation source 12. A light image 13 is created as light is reflected by the reflector 11. A camera 10, preferably a CCD sensing device, detects at least part of the light image 13 and converts the detected image to electrical signals, which are transmitted to a processing unit 14, such as a pre-programmed computer, and saved in a memory 16 associated with the processing unit 14. Using a signal processing algorithm programmed in the processing unit 14, the position of the center 18 of the reflector 11 can be calculated relative to the center 19 of the CCD device 10. The signal processing algorithm may include a sub-pixel resolution signal processing algorithm and may include any suitable algorithm known in the art for computing relative distances in this manner. The CCD camera 10 preferably comprises a CCD sensor, lens and light guide.

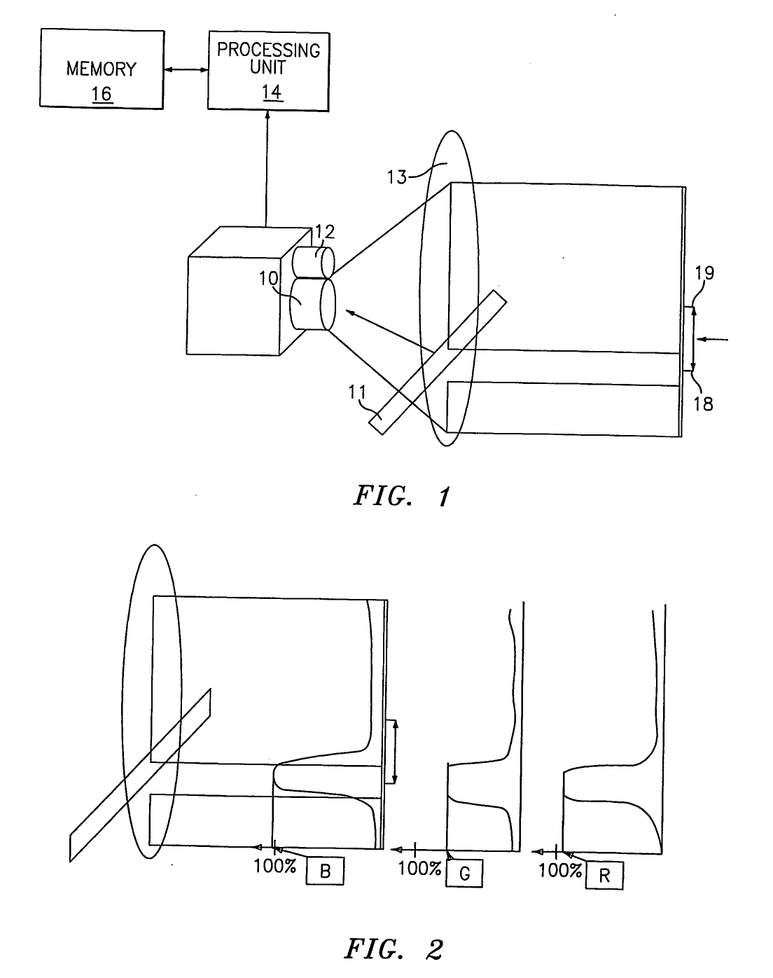

The CCD device 10 is preferably a color CCD sensing device. A color image thus detected by a color CCD 10, such as a color camera, may be decomposed into three primary color images—namely Red, Green, and Blue, as shown in FIG. 2. Modern color CCD's have a 12-bit color depth for each of these three colors, which means that, ideally, a color CCD can differentiate 2³⁶ colors. This implies that, ideally, one can encode 2³⁶ bits of information by using colors which can be decoded by using a color CCD sensor 10. Among the three primary colors, one color may be used for positioning, and may be called the position color. Under a given light source, all reflectors are equally colored regarding the positioning color in the sense that the intensity of the positioning color in a CCD image of each reflector is identical to each other, for example, 100% intensity. The positioning mechanism here is exactly identical to what is shown in FIG. 1. The other two primary colors may be called encoding colors and the combination of these two colors, after normalization with respect to the positioning color, will contain some specific position information. For example, consider that blue is the positioning color, while red and green are encoding colors. For up to 500 m buildings, 500 different colors are sufficient for position identification (considering that the sensing range of a typical CCD device 10 is 1.3 m). Hence 25 different color depths for each encoding color are sufficient. Let R, G, and B denote the intensity outputs of a color CCD standing for red, green, and blue colors, respectively, as shown in FIG. 2. Also, define RB and GB as follows:
R_{B}=[25×R/B], G_{B}=[25×G/B],
where [a] is equal to the maximum integer smaller than a, and the intensity of the positioning color is 100%. Note here that the normalization process shown in the above equation is desirable because non-uniform illumination intensity and any additional illumination such as sun light may change R, G, and B of a reflector with the same rate. The normalization process described herein removes the possibility of decoding errors caused by intensity variation.

A decoding table can be given as follows:

TABLE 1
Decoding Table

G_{B}

| | | | | | |
|---|---|---|---|---|---|
| | | 0 | 1 | . . . | 24 |
| | 0 | 1 | 2 | . . . | 25 |
| R_{B} | 1 | 26 | 27 | . . . | 50 |
| | 24 | 601 | 602 | . . . | 625 |

That is, if RB and GB are 1 and 24 respectively, then it can be seen from Table I that the decoded number is 50. From the decoded number, the specific color element of reflector 42 being illuminated can be determined and the position of the CCD device 10 and the elevator car to which it is attached can be calculated. In using this scheme, the colors on the reflectors may be chosen to guarantee their decoded position information is identical under expected variations in intensity of the light source.

In the event using 500 different color reflectors costs too much, one can use an array of different colors to encode position information. For example, a 4 cell array of a six-different-color reflector can cover more than 500 different conditions of position information.

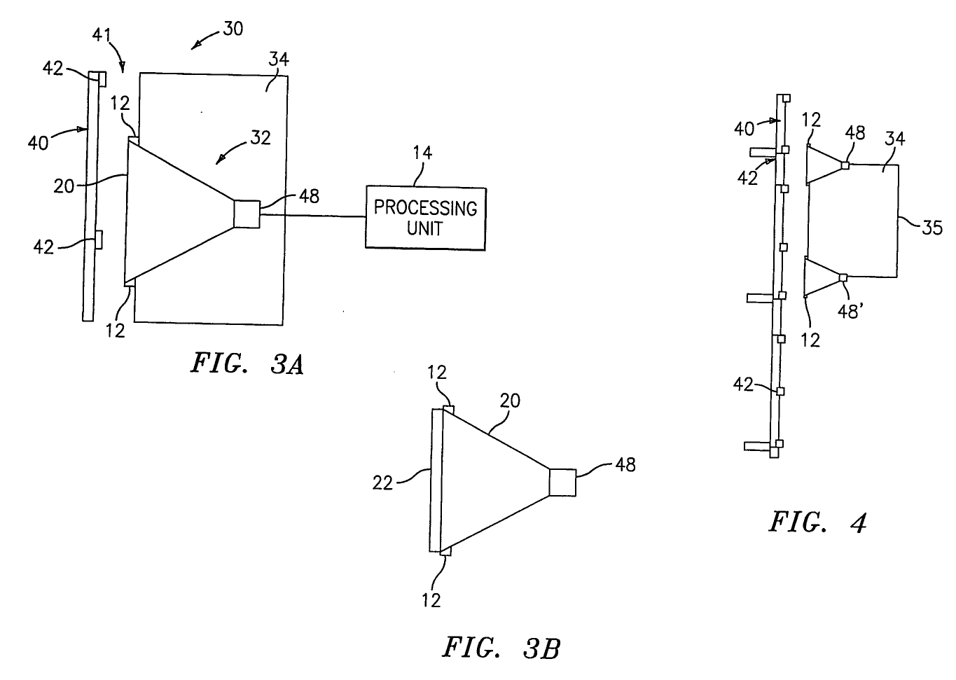

Referring now to FIGS. 3A and 3B, the configuration and operating mechanism of a position referencing system 30 in accordance with the present invention is depicted. In the system 30, a plurality of spaced apart reflectors or color elements 42 are mounted on a static structure, such as a door frame 40 or a wall, in a hoistway 41. A CCD assembly 32 including a CCD sensor box 48 is preferably attached to the frame 34 on a side of an elevator car, although it could be positioned elsewhere on the car such as the bottom of the car. One or more light sources 12 are provided on the frame 34 to illuminate a reflector 42 in the vicinity of the car.

In operation, light from the light source(s) 12 shine on a reflector 42 in the vicinity of the car. Light reflected by the reflector 42 is detected by the CCD sensor box 48 where it is converted into electrical signals representative of the primary colors—red, blue and green. The electrical signals are transmitted to a pre-programmed processor 14 so that the position of the elevator car can be determined. As described hereinabove, one of the primary colors—red, green, and blue is selected as the positioning color. The signals representative of the remaining primary colors are normalized as discussed above. From the normalized signals and a decode table stored in the memory associated with the processor 14, a decoded number for the detected reflector or color element 42 is determined. The decoded number identifies the detected reflector or color element 42. Using this information, and its location in the field of view of the CCD sensor box 48, the position of the elevator car can be determined.

If desired, the CCD sensor box 48 may also be used to detect the upper and lower edges of the reflector 42 in its field of view. Using electrical signals representative of the location of the upper and lower edges in the field of view of the CCD sensor box 48, a fine elevator car position can be determined.

Referring now to FIG. 3B, a configuration is shown therein which is devised to resolve two problems. One is about interfering ambient light. In this configuration, a sealed light guide 20 is used to address this problem. Further, for transparent hoistways, each light source 12 may be a polarized, linear light source. Additionally, if needed, a polarized window 22 may be provided on the sealed light guide 20. The provision of the polarized, linear light source(s) 12 and the polarized window 22 increases the signal to noise ratio against interfering ambient light.

The other problem, which this configuration addresses, is smoke. The linear light source 12 and the sealed light guide 20 provide a sufficiently clear image even in smoke conditions because the flight path of light in the smoke is minimized by using the linear light source 12 and the sealed light guide 20. Desirably, the distance between the reflector 42 and the CCD assembly 32 can be less than 3.0 cm.

For purposes of achieving a constant intensity of the reflector image regardless of the position of the reflector 42 with respect to the location of the CCD assembly 32, one can make the linear light source 12 have a non-uniform illumination intensity profile in space. For example, the illumination intensity of the light source 12 may be highest at both ends of the light source while it is lowest at the center of the light source.

FIG. 4 shows the configuration and operation of a CIC CCD based position referencing system. As shown in this Figure, a door frame 40 is provided with a plurality of color reflectors 42. Mounted to a frame 34 attached to an elevator car 35 is a CCD assembly 32 with an upper CCD sensing device 48 and a lower CCD sensing device 48′. At least one light source 12 is associated with each of the upper and lower sensing devices 48 and 48′.

Using the configuration of FIG. 4, one can achieve the following functions. One can achieve normal position feedback for the control system, assuming the distance between any two adjacent floors, except for the two floors at the ends of an express zone, is within 1.3 m plus the height of the car. The two CCD sensors 48 and 48′ provide high accuracy position as well as speed measurement at any point in the hoistway. In an express zone, there are a few reflectors at each of both ends of the express zone. As a result, the position referencing system of the present invention can provide precise positioning until the starting of the express zone and just after the ending of the express zone. The positioning in the express zone can be done by an open loop control since there is no stopping in an express zone. The same approach may be used for the case of large inter-floor distance such as the lobby of a hotel.

By installing reflectors every 1.3 m in the region of a normal terminal stopping device (NTSD) and emergency terminal stopping device/emergency terminal speed limiting device (ETSD/ETSLD), each CCD assembly 48 and 48′ provides speed and position measurement information independently, one for NTSD and the other for ETSD/ETSLD.

The system shown in FIG. 4 also provides the capability of minimized correction run. Assuming the distance between any two adjacent floors, except for two floors at the ends of an express zone, is within 1.3 m plus the height of the car, then the capability of no correction run can be achieved. In an express zone, one can attach a long reflector, which covers the upper/lower half of the express zone, or normal reflectors at normal inter-floor spacing. Then, based on the existence of the reflectors, the elevator car can decide at least where the closest floor to the car is. Deciding which way to move, up or down, may be the only function required after power comes back on. Note that attaching a long tape or individual CIC reflectors onto the hoistway can be done easily. Alternately, after the restoration of power, the elevator can arbitrarily creep up or down until a floor is found. This is still at most a one floor correction run.

The position referencing system and method of the present invention provides numerous advantages: (1) higher accuracy everywhere in the hoistway or guideway; (2) higher position update rate; (3) lower installation cost with little or no hoistway or guideway installation; (4) lower maintenance cost due to simple structure, no mechanical wear, and easy maintenance; (5) lower management cost due to global applicability; and (6) minimized correction run.

While the position referencing system of the present invention has been described in the context of an elevator position referencing system, the same system could be used to determine the position of a horizontal passenger conveyance system. In such a system, the static structure would be a door frame in a transport guideway and the movable structure would be a device or passenger cab for conveying people substantially horizontally or at an angle with respect to a horizontal axis. One or more light sources and a sensing device may be fixed to the movable structure.

While the position referencing system of the present invention has been described in the context of a sensing device 10 for detecting red, green and blue colors, the sensing device could also detect invisible colors having a unique wavelength in the magnetic spectrum including, but not limited to, ultraviolet, infrared, radio frequency and microwave. In this regard, each color element 42 could reflect a unique wavelength of the electromagnetic spectrum.

It is apparent that there has been provided in accordance with the present invention a position referencing system which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A position referencing system comprising:
a plurality of spaced apart color elements attached to a static structure;
means attached to a movable structure for detecting one of said spaced apart color elements; and
means for determining a position of said movable structure from said detected color element.

2. A position reference system according to claim 1, wherein said static structure is an elevator hoistway and said movable structure is an elevator car.

3. A position referencing system according to claim 2, wherein said detecting means comprises at least one camera for determining the color of said detected color element and for detecting a top edge and a bottom edge of said detected color element.

4. A position referencing system according to claim 3, wherein each said color element reflects a unique wavelength of the electromagnetic spectrum.

5. A position referencing system according to claim 3, wherein said at least one camera is mounted to a side of said elevator car, said static structure is a door frame in said hoistway, and said plurality of spaced apart color elements comprises a plurality of differently colored elements attached to said door frame.

6. A position referencing system according to claim 3, wherein said detecting means detects a plurality of unique color components of said detected color element and said determining means selects one of said plurality of unique color components as a positioning color, normalizes the remaining ones of said plurality of unique color components with respect to the positioning color, determines a decoded number for the detected color element from said normalized ones of said plurality of unique color components, and identifies the detected color element from the decoded number.

7. A position referencing system according to claim 3, wherein said detecting means further comprises a linear radiation source for illuminating said detected one of said color elements and a camera apparatus.

8. A position referencing system according to claim 7, wherein said camera apparatus comprises a CCD camera.

9. A position referencing system according to claim 8, wherein said CCD camera comprises a CCD sensor, lens, and light guide.

10. A position referencing system according to claim 3, wherein said detecting means comprises a first camera apparatus attached to a first part of said elevator car and a second camera apparatus attached to a second part of said elevator car and wherein said first and second camera apparatus operate independently to provide redundant speed and position information.

11. A position referencing system according to claim 1, wherein said static structure is a transport guideway and said movable structure is a passenger cab.

12. A position referencing system according to claim 11, wherein said detecting means comprises at least one camera for determining the color of said detected color element and for detecting a top edge and a bottom edge of said detected color element.

13. A position referencing system according to claim 12, wherein said color element reflects a unique wavelength of the electromagnetic spectrum.

14. A position referencing system according to claim 12, wherein said at least one camera is mounted to a side of said passenger cab, said static structure is a door frame in said transport guideway, and said plurality of spaced apart color elements comprises a plurality of differently colored elements attached to said door frame.

15. A position referencing system according to claim 12, wherein said detecting means detects a plurality of unique color contents of said detected color element and said determining means selects one of said plurality of unique color components as a positioning color, normalizes the remaining ones of said plurality of unique color components with respect to the positioning color, determines a decoded number for the detected color element from said normalized ones of said plurality of unique color components, and identifies the detected color element from the decoded number.

16. A position referencing system according to claim 12, wherein said detecting means comprises a linear radiation source for illuminating said detected one of said color elements and a camera apparatus.

17. A passenger transport position referencing system according to claim 16, wherein said camera apparatus comprises a CCD camera.

18. A passenger transport position referencing system according to claim 17, wherein said CCD camera comprises a CCD sensor, lens, and light guide.

19. A passenger transport position referencing system according to claim 12, wherein said detecting means comprises a first camera apparatus attached to a first part of said passenger cab and a second camera apparatus attached to a second part of said passenger cab and wherein said first and second camera apparatus operate independently to provide redundant speed and position information.

20. A method for determining the position of a movable structure comprising the steps of:
attaching a plurality of spaced apart color elements to a static structure;
detecting one of said spaced apart color elements using a sensing device attached to said movable structure; and
determining a position of said movable structure from said detected color element.

21. A method according to claim 20, wherein said detecting step comprises illuminating said color element with a radiation source and capturing a reflected image with a sensing device.

22. A method according to claim 20, wherein said detecting step comprises capturing a reflected color light image containing a plurality of primary colors and said determining step comprises selecting one of said primary colors as a positioning color and normalizing the remaining colors with respect to said positioning color.

23. A method according to claim 22, wherein said position determining step comprises determining a decode number for said color element and from said decode number identifying said color element and determining the position of said moveable structure.
